(19) United States
(12) Patent Application Publication
(10) Pub. No.: US 2015/0351017 A1
(43) Pub. Date: Dec. 3, 2015

(54) Verifying stored location data for WLAN access points

(71) Applicant: Nokia Technologies Oy, Espoo (FI)

(72) Inventors: Lauri Aarne Johannes Wirola, Tampere (FI); Tommi Antero Laine, Tampere (FI)

(21) Appl. No.: 14/759,269

(22) PCT Filed: Jan. 11, 2013
(86) PCT No.: PCT/IB2013/050264

§ 371 Date: Jul. 6, 2015

(51) Int. Cl. H04W 48/16; H04W 4/02

(52) U.S. Cl. CPC H04W 48/16; H04W 4/021; H04W 84/12

(57) ABSTRACT

An apparatus receives information on a first set of wireless local area network access points obtained in a scan at a single location, the information including at least an identifier of each access point. The same or another apparatus retrieves from a database, based on the identifiers, location data for a second set of access points, the second set of access points comprising access points of the first set of access points for which location data is available in the database. The same or another apparatus determines, based on retrieved location data for the second set of access points and on a predetermined criterion, whether location data for any of the access points of the second set of access points represent an outlier. The same or another apparatus provides identifiers for a third set of access points that are not to be used for positioning purposes, the third set of access points comprising access points of the second set of access points for which the retrieved location data has been determined to represent outliers.

### FIELD OF THE DISCLOSURE The invention relates to stored location data for wireless local area network access points, and more specifically to a verification of such data.

### BACKGROUND

Modern global cellular and non-cellular positioning technologies are based on generating large global databases containing information on cellular and non-cellular signals. The information may originate entirely or partially from users of these positioning technologies. This approach is also referred to as “crowd-sourcing”.

The information provided by users is typically in the form of “fingerprints”, which contain a location that is estimated based on, e.g., received satellite signals of a global navigation satellite system (GNSS) and measurements taken from one or more radio interfaces for signals of a cellular and/or non-cellular terrestrial system. In the case of measurements on cellular signals, the results of the measurements may contain a global and/or local identification of the cellular network cells observed, their signal strengths and/or pathlosses and/or timing measurements like timing advance (TA) or round-trip time. For measurements on wireless local area network (WLAN) signals, as an example of signals of a non-cellular system, the results of the measurements may contain a basic service set identification (BSSID), like the medium access control (MAC) address of observed access points (APs), the service set identifier (SSID) of the access points, and the signal strength of received signals (received signal strength indication RSSI or physical Rx level in dBm with a reference value of 1 mW, etc.).

This data may then be transferred to a server or cloud, where the data may be collected and where further models may be generated based on the data for positioning purposes. Such further models can be coverage area estimates, node positions and/or radio channel models, with base stations of cellular communication networks and access points of WLANs being exemplary nodes. In the end, these refined models may be used for estimating the position of mobile terminals.

Fingerprints do not necessarily have to comprise a GNSS based position. They could also include cellular and/or WLAN measurements only. In this case the fingerprint could be assigned a position for example based on a WLAN based positioning in a server. Such self-positioned fingerprints can be used to learn cellular network information, in case there are cellular measurements in the fingerprint. Moreover, in a set of WLAN measurements in a fingerprint there may be, in addition to measurements for known WLAN access points, also measurements for unknown access points, and the position of the unknown access points can be learned through these self-positioned fingerprints. Finally, more data can be learned for previously known access points based on self-positioned fingerprints.

It may be noted that even when using a mobile terminal having GNSS-capabilities, a user may benefit from using cellular/non-cellular positioning technologies in terms of time-to-first-fix and power consumption. Also, not all applications require a GNSS-based position. Furthermore, cellular/non-cellular positioning technologies work indoors as well, which is generally a challenging environment for GNSS-based technologies.

### SUMMARY OF SOME EMBODIMENTS OF THE INVENTION

A method is described which comprises at at least one apparatus receiving information on a first set of wireless local area network access points obtained in a scan at a single location, the information including at least an identifier of each access point. The method further comprises retrieving from a database, based on the identifiers, location data for a second set of access points, the second set of access points comprising access points of the first set of access points for which location data is available in the database. The method further comprises computing a position based on retrieved location data for the second set of access points. The method further comprises determining, based on retrieved location data for the second set of access points and on a predetermined criterion, whether location data for any of the access points of the second set of access points represent an outlier. The method further comprises providing identifiers for a third set of access points that are not to be used for positioning purposes, the third set of access points comprising access points of the second set of access points for which the retrieved location data has been determined to represent outliers.

Moreover a first system is described, which comprises means for realizing the actions of the presented method.

The means of the system can be implemented in hardware and/or software. They may comprise for instance at least one processor for executing computer program code for realizing the required functions, at least one memory storing the program code, or both. Alternatively, they could comprise for instance circuitry that is designed to realize the required functions, for instance implemented in a chipset or a chip, like an integrated circuit. In general, the means may comprise for instance one or more processing means.

Moreover a second system is described, which comprises at least one processor and at least one memory including computer program code, the at least one memory and the computer program code configured to, with the at least one processor, cause at least one apparatus at least to perform the actions of the presented method.

Any of the described systems may be an apparatus or comprise a plurality of apparatuses. In the latter case, the means of the presented first system could be distributed for instance to a plurality of apparatuses. Similarly, the at least one processor and the at least one memory of the presented second system could be distributed for instance to a plurality of apparatuses. Any mentioned apparatus may be a module or a component for a device, for example a chip. Alternatively, any of the mentioned apparatuses may be a device, for instance a server.

Any of the described systems may further comprise only the indicated components or one or more additional components. For example, any of the systems may optionally comprise in addition the database storing the location data and/or a mobile terminal or another apparatus providing the information on the first set of wireless local area network access points.

In certain embodiments, the described methods are information providing methods, and the described systems are or comprise information providing apparatuses.

In certain embodiments of the described methods, the methods are methods for verifying stored location data. In certain embodiments of the described systems, the systems are systems for verifying stored location data.

Moreover a non-transitory computer readable storage medium is described, in which computer program code is stored. The computer program code causes at least one apparatus to perform the actions of the presented method when executed by at least one processor.

The computer readable storage medium could be for example a disk or a memory or the like. The computer program code could be stored in the computer readable storage medium in the form of instructions encoding the computer-readable storage medium. The computer readable storage medium may be intended for taking part in the operation of a device, like an internal or external hard disk of a computer, or be intended for distribution of the program code, like an optical disc.

It is to be understood also the respective computer program code by itself has to be considered an embodiment of the invention. The computer program code could also be distributed to several computer readable storage mediums.

It is to be understood that the presentation of the invention in this section is merely exemplary and non-limiting.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of an exemplary embodiment of a system;

FIG. 2 is a flow chart illustrating an exemplary embodiment of a method;

FIG. 3 is a schematic block diagram of another exemplary embodiment of a system;

FIG. 4 is a flow chart illustrating an exemplary first operation in the system of FIG. 3;

FIG. 5 is a diagram illustrating an exemplary structure of a WLAN object in a database;

FIG. 6 is a diagram schematically illustrating an exemplary determination of outliers; and

FIG. 7 is a flow chart illustrating an exemplary second operation in the system of FIG. 3.

### DETAILED DESCRIPTION OF THE FIGURES

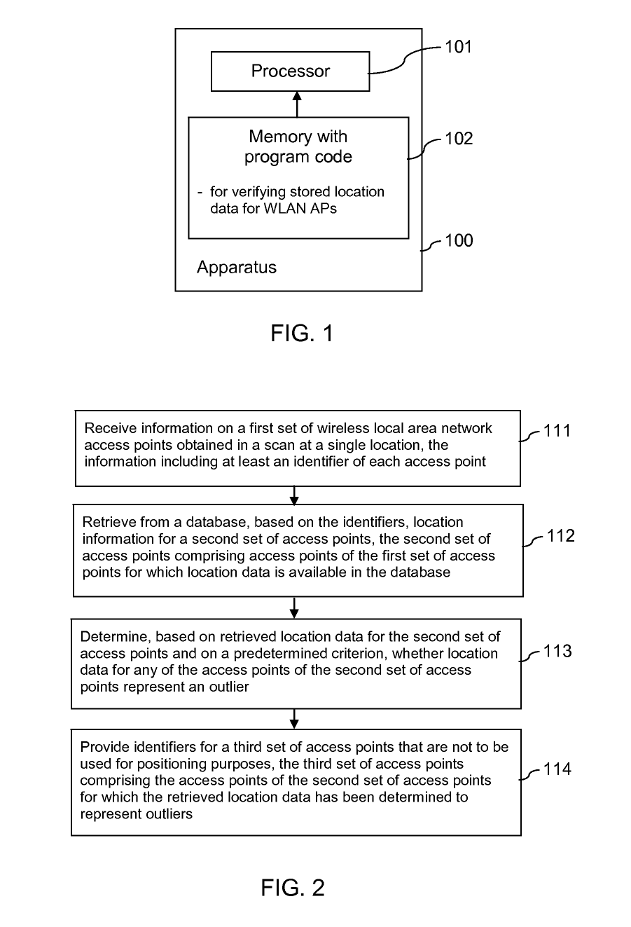

FIG. 1 is a schematic block diagram of an exemplary embodiment of a system in the form of an exemplary apparatus 100. Apparatus 100 comprises a processor 101 and, linked to processor 101,a memory 102. Memory 102 stores computer program code for verifying stored location data for WLAN access points. Processor 101 is configured to execute computer program code stored in memory 102 in order to cause an apparatus to perform desired actions.

Apparatus 100 could be a server or any other device. Apparatus 100 could equally be a module, like a chip, circuitry on a chip or a plug-in board, for a server or for any other device. Optionally, apparatus 100 could comprise various other components, like a data interface, a user interface, a further memory, a further processor, etc.

An operation of apparatus 100 will now be described with reference to the flow chart of FIG. 2. The operation is an exemplary embodiment of a method according to the invention. Processor 101 and the program code stored in memory 102 cause an apparatus to perform the operation when the program code is retrieved from memory 102 and executed by processor 101. The apparatus that is caused to perform the operation can be apparatus 100 or some other apparatus, for example but not necessarily a device comprising apparatus 100.

The apparatus receives information on a first set of wireless local area network access points obtained in a scan at a single location, the information including at least an identifier of each access point. (action 111)

The apparatus retrieves from a database, based on the identifiers, location data for a second set of access points, the second set of access points comprising access points of the first set of access points for which location data is available in the database. (action 112) It is to be understood that the second set of access points may but does not have to include all access points for which location data is available in the database. Some of the available location data may for example be blacklisted and therefore be ignored.

The apparatus determines, based on retrieved location data for the second set of access points and on a predetermined criterion, whether location data for any of the access points of the second set of access points represent an outlier. (action 113)

The apparatus provides identifiers for a third set of access points that are not to be used for positioning purposes, the third set of access points comprising access points of the second set of access points for which the retrieved location data has been determined to represent outliers. (action 114)

The invention proceeds from the consideration that many mobile devices support tethering. For tethering, a mobile device has Internet connectivity and shares this connectivity with surrounding devices via WLAN. The mobile device thus acts like a WLAN access point from the perspective of the other devices. For a WLAN based positioning that makes use of user collected data on WLAN access points, this is a great challenge, because it means that some of the collected data may relate to “moving WLAN access points”, which may distort the positioning results.

WLAN access points are identified by a BSSID address. With MAC-48/EUI-48, the BSSID-address structure may comprise 6 bytes that are distributed as follows:
3 Most Significant Bytes: Organizationally Unique Identifier (OUI)
3 Least Significant Bytes: OUI-specific ID

With EUI-64 (8 bytes), the BSSID-address structure may comprise 8 bytes that are distributed as follows:
3 Most Significant Bytes: Organizationally Unique Identifier (OUI)
3 Least Significant Bytes: OUI-specific ID or
36 Most Significant Bits: Company Identifier
28 Least Significant Bits: Company-specific ID

Now, some tethering devices identify themselves as “ad-hoc” networks, which allows excluding information on such access points when generating and updating a database containing location data for WLAN access points and/or when performing a positioning using stored data for WLAN access points. However, many mobile devices identify themselves as “infrastructure” networks, meaning that they cannot be distinguished from the “fixed” access points.

Mobile devices that are capable of tethering and that do not identify themselves as ad-hoc access points introduce multiple issues for positioning systems using crowd-sourced WLAN access point location databases. Such tethered devices may cause large positioning errors. Moreover, they increase the database size unnecessarily, because information on such devices is inherently unsuitable for positioning and could thus be left outside of the database. When using stored WLAN-based location information for learning the locations of further WLAN access points for updating the database, the positioning errors furthermore cause database corruption.

Certain embodiments of the invention therefore provide that identifiers of several access points that have been detected at a particular location are used for obtaining stored location data, and the obtained location data is evaluated for determining whether the obtained location data for any of the access points appears to represent an outlier in view of the obtained location data as a whole. Stored location data that was used in the positioning but that appears to represent an outlier is assumed not to be suitable for positioning purposes. Such location data may be in particular data on the old location of mobile devices that are being used for tethering.

Certain embodiments may thus enable a verification of stored location data for WLAN access points by implementing an outlier detection schemes. This may have the effect that a more reliable positioning service is enabled, because stored location data for tethered devices can be detected automatically.

Apparatus 100 illustrated in FIG. 1 and the method illustrated in FIG. 2 may be implemented and refined in various ways.

In an exemplary embodiment, the identifier of each access point comprises a BSSID. Alternatively or in addition, it could comprise any other suitable identifier, like a MAC address.

In an exemplary embodiment, the information on the first set of access points is received in a positioning request for a mobile device that collected the information in the scan. The method may further comprise in this case determining a position based on location data for access points of the second set of access points, excluding at least one of the access points of the third set of access points and access points identified in a blacklist, and providing the determined position as a position of the mobile device. This may have the effect that the location data that is stored for mobile devices acting as WLAN access points can be ignored in the computation of the position of the mobile device and that the quality of the positioning is improved. It is to be understood that the request may be assembled and provided by the mobile device itself or by some other entity. Accordingly, the computed position may be provided to the mobile device itself or to some other entity. The blacklist can be a blacklist that has previously been generated in a manner as will be described further below.

In an exemplary embodiment, the identifiers of the third set of access points are stored in a memory. This may have the effect that determined outliers may not only be ignored in a current positioning, but alternatively or in addition be used as a basis for future selections of suitable database entries.

An exemplary embodiment further comprises assembling a blacklist based on identifiers of a plurality of provided third sets of access points. The blacklist identifies entries of the database that are not to be used for learning or positioning purposes. This may have the effect that comprehensive information on outliers may be exploited for blocking the use of unsuitable database entries.

It is to be understood that the blacklist could be a separate list or that it could be provided by marking the entries of the database to be blacklisted using some special parameter of the entries.

It is further to be understood that the blacklist could simply be an assembly of the provided identifiers for a plurality of third sets of access points, or the result of a further analysis of the provided identifiers for a plurality of third sets of access points. The latter approach may enable a blocking of potentially unsuitable database entries for access points that did not appear in a third set of access points so far.

Generating a blacklist based on determined outliers has moreover to be considered an embodiment of the invention of its own.

A blacklist could be generated for example for certain BSSID-address ranges. As indicated above, a BSSID address has an internal structure in which the most significant part relates to an organization or company and in which the least significant part can be freely used by the organization or company.

In an exemplary embodiment, it may be determined for a given company or organization identifier at least one of a number of access points in third sets of access points and a ratio of access points in third sets of access points, wherein a respective company or organization identifier is a part of an identifier of an access point. If the at least one of the number and the ratio exceeds a threshold value, the company or organization identifier may be added to the blacklist. This approach may thus have the effect that all access points identified in part by this organization and/or company identifier can be blacklisted without requiring any information from the organization or company.

Blacklisting the entire range of identifiers including a particular company or organization identifier takes account of the fact that some companies or organizations sell only or mainly mobile devices supporting tethering and no or little stationary devices providing a WLAN access point. To exemplify, Nokia does not manufacture fixed WLAN access points, but Nokia devices do support tethering. Thus it may be that all BSSIDs showing Nokia as organization or company can be blacklisted. Other vendors might have several organization or company identifiers. For instance, there might be one company or organization identifier for fixed WLAN access points and another company or organization identifier for mobile devices. Thus, all BSSIDs comprising the company or organization identifier for mobile devices can be blacklisted. Blacklisting all of the location data for a particular company or organization identifier may have the effect that a large number of potentially unsuitable database entries may be blocked from use, for which no separate verification has been performed so far.

In another exemplary embodiment, it may be determined for a given company or organization identifier whether there is a range of identifiers of access points for which at least one of a number of access points in the third sets of access points and a ratio of access points in the third sets of access points exceeds a threshold value, wherein a respective company or organization identifier is a part of an identifier of an access point. If the at least one of the number and the ratio exceeds the threshold value, information indicating the range of identifiers of access points may be added to the blacklist.

This approach takes account of the fact that some vendors use different subspaces within an assigned BSSID space for mobile and fixed devices. For instance, a vendor might decide to divide the 3 bytes that are available for free use (range [0, 16777215] ) into two parts so that the range [0, 8388607] is used for mobile devices and the range [8388608, 16777215] for fixed access points. The presented approach may then have the effect that the BSSID ranges employed for mobile devices can be blacklisted without requiring information on the employed ranges from the company or organization.

In each case, comparing absolute numbers to a threshold has the effect that it may be ensured that sufficient data has been collected for a particular company or organization for enabling a reliable decision on whether to blacklist an identifier of a company or organization or an identifier range used by a company or organization. Comparing a ratio to a threshold may have the effect that an identifier of a company or organization or an identifier range used by a company or organization is not put on a blacklist simply because it provides a relatively large number of access points, even though only a small portion may be access points offered by tethered mobile devices. Comparing absolute numbers and ratios to a respective threshold value may be suited to take account of both aspects.

It is to be understood that certain embodiments of a system may comprise a plurality of apparatuses and that the presented functions may also be implemented in a distributed manner to these apparatuses in the system.

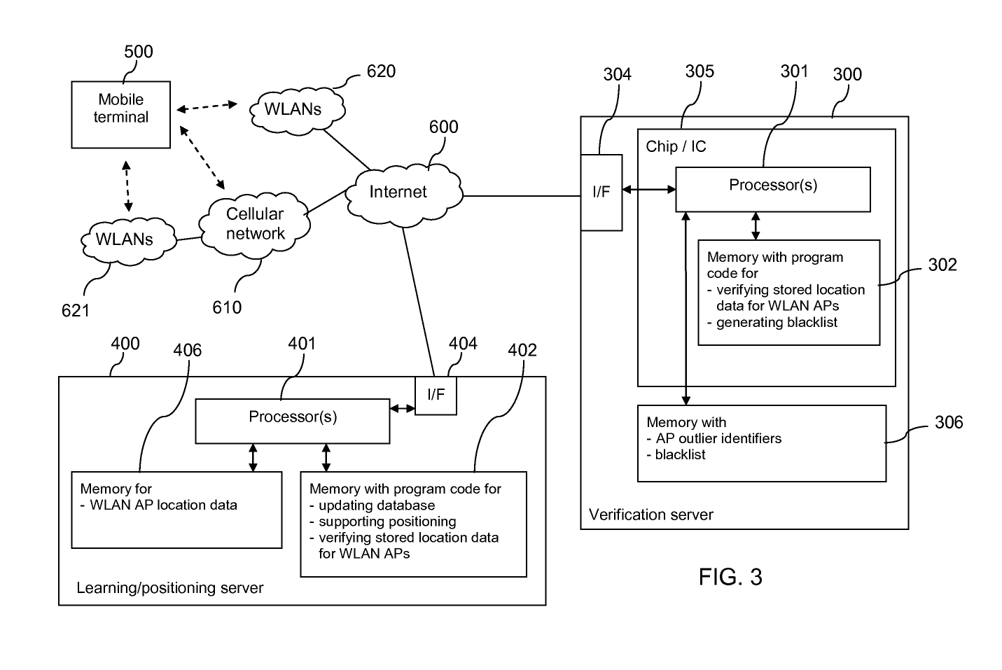

FIG. 3 is a schematic block diagram of a further exemplary embodiment of a system, which supports a verification of location data for WLAN access points that is stored and updated for supporting a positioning of mobile devices.

The system comprises a first server 300 and a second server 400. Each of the servers 300, 400 is connected to a network 600, for example the Internet. Servers 300 and 400 could also belong to network 600. The system comprises in addition a mobile terminal 500. Mobile terminal 500 is able to access network 600 via a cellular network 610 and/or via an access point of a fixed WLAN 620 and/or via an access point of a WLAN 621 that is provided by another mobile device supporting tethering and further via cellular network 610.

Server 300 may be for instance a dedicated verification server, or some other kind of server. It comprises a processor 301 that is linked to a first memory 302, to a second memory 306 and to an interface (I/F) 304. Processor 301 is configured to execute computer program code, including computer program code stored in memory 302, in order to cause server 300 to perform desired actions.

Memory 302 stores computer program code for verifying stored location data for WLAN access points and computer program code for generating a blacklist. The computer program codes may comprise for example similar program codes as memory 102. In addition, memory 302 may store computer program code implemented to realize other functions, as well as any kind of other data.

Processor 301 and memory 302 may optionally belong to a chip or an integrated circuit 305, which may comprise in addition various other components, for instance a further processor or memory.

Memory 306 can be accessed by processor 301. It is configured to store identifiers of access point outliers and a blacklist. In addition, memory 306 could store other data. It is to be understood that a memory storing the data could also be external to server 300; it could be for instance on another physical or virtual server.

Interface 304 is a component which enables server 300 to communicate with other devices, like server 400, via network 600. Interface 304 could comprise for instance a TCP/IP socket.

Component 305 or server 300 could equally correspond to exemplary embodiments of a system according to the invention.

Server 400 may be for instance a dedicated positioning server, a position data learning server, or some other kind of server. It may have a similar structure as server 300, including a processor 401, a memory 402 with program code, an interface 404 and a memory 406.

In this case, memory 406 could comprise data of a WLAN access point location database. The database could be a database for storing radio channel models including a respective access point position and pathloss model. The radio channel models could be used as a basis for a positioning of mobile terminals. Such a database can also be referred to as a radiomap database. Memory 406 could comprise in addition collected fingerprint data stored in the form of a grid. The radio channel models could be computed and updated based on the stored fingerprint data.

The program code in memory 402 may comprise code for updating the stored fingerprint data based on received fingerprint data and/or code for updating the radio channel models and/or code for supporting a positioning using the stored data. In addition, it may comprise program code for supporting a verification of stored location data for WLAN access points.

Mobile terminal 500 is configured to scan for WLAN access points in its environment and to prepare and send a positioning request to server 400. The request can be transmitted either via one of the WLANs 620, 621 or directly via cellular network 610.

Cellular communication network 610 could be based on any kind of cellular system, for instance a GSM system, a 3rd Generation Partnership Project (3GPP) based cellular system like a WCDMA system or a TD-SCDMA system, e.g. supporting high speed packet access (HSPA), a 3GPP2 system like a CDMA2000 system, a LTE or LTE-Advanced system, or any other type of cellular system, like a worldwide interoperability for microwave access (WiMAX) system.

Each of the WLANs 620, 621 comprises at least one access point. To each access point, a BSSID has been assigned.

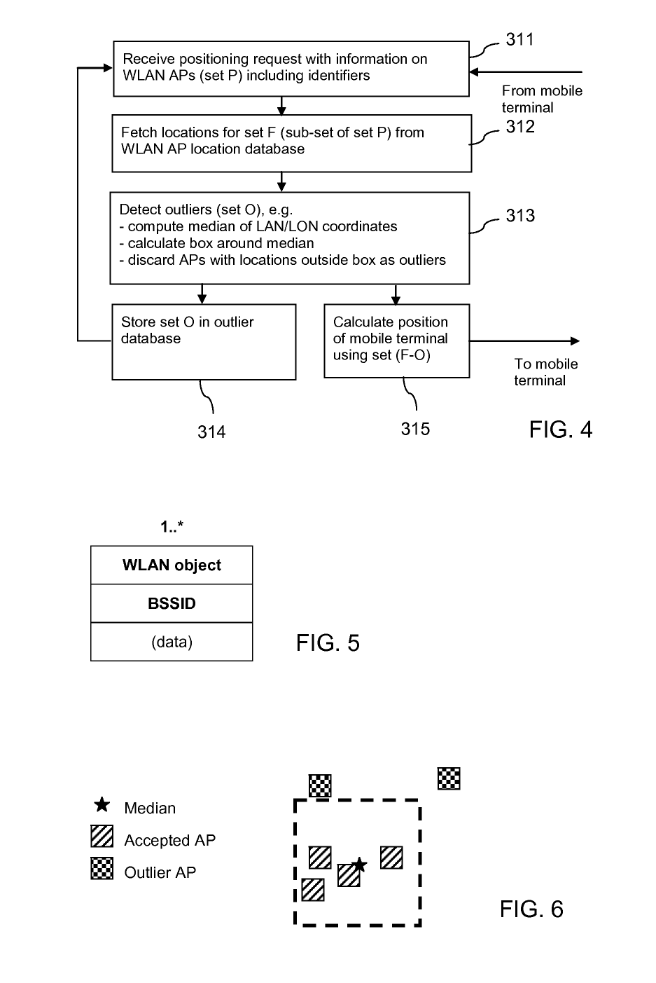

Exemplary operations in the system of FIG. 3 will now be described with reference to FIGS. 4 to 7.

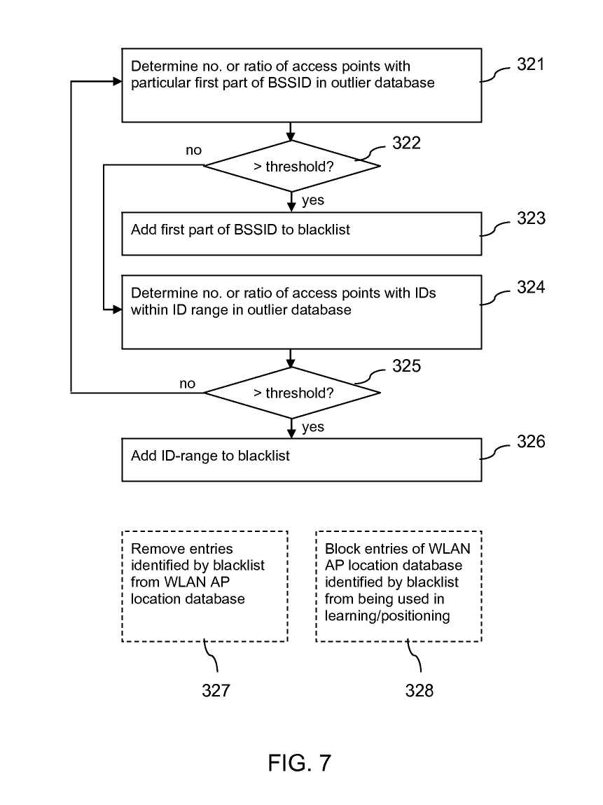

FIGS. 4 and 7 are flow charts illustrating operations at servers 300 and 400. Processor 301 and some of the program code stored in memory 302 cause server 300 to perform some of the presented operations when the program code is retrieved from memory 302 and executed by processor 301, while processor 401 and some of the program code stored in memory 402 cause server 400 to perform some of the presented operations when the program code is retrieved from memory 402 and executed by processor 401.

When mobile terminal 500 needs to know its position, it performs a WLAN scan and sends a positioning request to server 400. The positioning request includes the BSSID addresses of the detected WLAN access point and other information for each access point, such as Rx level measurements. The set of detected access points is referred to as set P.

Server 400 receives the request. (action 311)

Server 400 accesses memory 406 to retrieve location data for the access points of set P from the WLAN access point location database, as far as available. (action 312) The database may be indexed using the BSSID as the primary key. Such an indexing is illustrated in FIG. 5, where to each stored WLAN object, a BSSID is indicated as the primary key for enabling a selection of stored data. As indicated by the notation is 1 . . .* in FIG. 5, there may be at least one WLAN object, and the count is unrestricted. Thus, the location data for a respective WLAN access point may be easily extracted, since the BSSID is available. The location data for a respective access point may include the Latitude and Longitude coordinates of the access point.

The database will most likely contain only data for some of the access points of set P. Retrieving data will thus result in obtaining the location data for a subset of set P, which will be referred to as set F. Only set F will be considered in the following, since set P-F is unusable in positioning.

Server 400 may send the BSSIDs for set F to server 300 along with the retrieved associated location data.

Server 300 now takes care of detecting outliers. (action 313) To this end, it analyzes which access points of set F seem suspicious with respect to the majority of access points in set F.

The outliers may be determined in many ways using some predetermined criterion. A simple approach is illustrated in FIG. 6.

FIG. 6 is a diagram which shows six access points as small boxes. These access points represent the access points in set F. Server 300 computes the median of the Latitude and Longitude coordinates of the six access points. The median is shown in FIG. 6 as a star. Next, server 300 calculates a square around the median. The median is the center of the square, and the edges of the square, shown in FIG. 6 with dashed lines, have a predetermined length. The length of an edge can be for example a few hundred meters. The access points within the square, indicated by hatched boxes, are accepted. The access points outside of the square, indicated by checkered boxes, are discarded as outliers. The location of an access point lying outside of a square of predetermined size around the determined position is thus an exemplary predetermined criterion for determining that location data for a certain access point represents an outlier.

It is to be understood that instead of using the median, some other position could be used. For example, a position resulting in a regular positioning for mobile terminal 500 could be performed, taking into account in addition the Rx level measurements. Also the use of a square is only exemplary. Instead, for instance an acceptable distance to the median or any other position could be used as a predetermined criterion. Furthermore, outliers could also be determined without computing a position first. For instance, it could be determined whether the minimum distance of the location indicated by the location data for an access point of set F to the location indicated by the location data for any of the other access points of set F is larger than a threshold value, and if so, this access point could be determined to be an outlier, etc,

The set of outliers will be referred to as set O, which is a subset of set F.

Server 300 stores the BSSIDs of set O as data of an outlier database in memory 306 for later use. (action 314)

In addition, server 300 may send the BSSIDs of set F-O to server 400. Server 400 may then calculate the position of mobile terminal 500 using available information on set F-O. (action 315) The determined position may then be transmitted to mobile terminal 500.

The process is continued with action 311, when another positioning request is received from some mobile terminal Optionally, some access points in a new set F obtained in action 312 may be excluded right away in action 313, if the associated BSSIDs have previously been stored as outliers in memory 306.

When a certain amount of outlier identifiers has been collected in memory 306 using the approach of FIG. 4, the data may be analyzed to determine complete ranges of BSSIDs that should be excluded from consideration. This can be achieved by detecting clusters of outlier BSSIDs in the blacklist in memory 306, as illustrated by FIG. 7.

As indicated above, a BSSID comprises a first part identifying a particular company or organization and a second part identifying a particular access point provided by the identified company or organization. There may be several first parts of BSSIDs that are assigned to a single company or organization.

In a first analysis, server 300 determines the WLAN access points that are identified in the outlier database and thus in memory 306 with the same first part of a BSSID, and then determine the number of WLAN access points that are identified by a particular first part of a BSSID. Optionally, the number of access points that are identified in the WLAN access point location database and thus in memory 406 by the same first part of a BSSID may be determined in addition. In this case, the ratio of the number of outliers with the particular first part of a BSSID to the number of entries in the WLAN access point location database with this particular first part of a BSSID may be determined (action 321)

Next, server 300 determines whether the number of outliers, and/or the ratio, exceeds a respective predetermined threshold value. (action 322) In the case of a ratio, the threshold value could be for instance 0.5, meaning that if the threshold is exceeded, more than 50 percent of the entries in the WLAN access point location database can be considered to represent outliers. In the case of absolute numbers, the threshold value could be set for instance to one half of the available BSSID space for the second part of BSSIDs using a particular first part of a BSSID, for example one half of the number space provided by the 3 Least Significant Bytes in the case of MAC-48 and thus 2²⁴/2=8,388,608. It is to be understood that any other values could be selected. By reducing the respective threshold value, the number of outliers can be reduced but less valid data may remain for consideration. By increasing the respective threshold value, more valid data remains for consideration, but more outliers may remain for falsifying the results.

If the at least one threshold value is exceeded, it can be deduced that the access points identified by this particular first part of a BSSID are primarily tethered devices and should be excluded from positioning and/or learning computations at server 400. Thus, the first part of the BSSID is added to the blacklist in memory 306. (action 323)

If the number of outliers, and/or the ratio, does not exceed the at least one predetermined threshold value in action 322, the access points that are identified by the first part of a BSSID are not excluded from positioning on a general basis. Still, it may be checked in addition for the particular first part of a BSSID, whether there are certain ranges of the second part of a BSSID that should be blacklisted.

To this end, server 300 determines the number of access points that are identified by a BSSID within a certain range of BSSIDs in the outlier database. Optionally, the number of access points that are identified in the WLAN access point location database by the same range of BSSIDs may be determined in addition. In this case, the ratio of the number of outliers within a particular range of BSSIDs to the number of entries in the radiomap database with this particular range of BSSIDs may be determined. Further optionally, the proportion of the access points that are identified by a BSSID within the range of BSSIDs in the outlier database as compared to all access points that are identified in the outlier database may be determined, and the proportion of the access points that are identified by a BSSID within the range of BSSIDs in the WLAN access point location database as compared to all access points that are identified in the WLAN access point location database may be determined A ratio of the first proportion to the latter proportion may then be determined (action 324)

Next, server 300 determines whether the number of outliers, and/or the ratio, exceeds at least one predetermined threshold value. (action 325)

If the at least one threshold value is exceeded, the range is added to the blacklist in memory 306. (action 326)

The range detection as performed in actions 324 to 326 could be implemented for example as follows.

A company or organization using an ID of A57F3C could be detected to have many access points that are identified in the outlier database, even though the at least one threshold checked in action 322 is not exceeded.

The range search within this BSSID space could be implemented in 256 blocks, with 2¹⁶=65536 addresses each:

1st block: A57F3C 000000 to A57F3C 00FFFF
2nd block: A57F3C 010000 to A57F3C 01FFFF
...
256th block: A57F3C FEFFFF to A57F3C FFFFFF

If it is now detected in actions 324 and 325 that in the blocks 1 to 16 there are proportionally more access points in the outlier database than in the WLAN access point location database, the BSSID range from A57F3C 000000 to A57F3C 0FFFFF may be added to the blacklist in action 326. The threshold value in action 325 that is used for comparing the ratio of proportions may be set to a value larger than one to allow ignoring only slight mismatches in proportions.

Alternatively, if more than a certain percentage of the access points identified in the WLAN access point location database for a certain BSSID range, e.g. more than half, are listed in the outlier AP database, this BSSID range may be added to the blacklist in action 326.

Further alternatively, the decision can be based on absolute numbers as well. For example, in case in the blocks 1-16, with a maximum of 16*2¹⁶=1048576 access points, there are more than 16*2¹⁶/2=524288 access points that have been marked as outliers, then the whole range A57F3C 000000 to A57F3C 0FFFFF can be added to the blacklist in action 326.

It is to be understood that it would also be possible to use actions 321-323 only or actions 324 to 326 only.

The process may then continue with action 321 for the next first part of BSSIDs.

When the entire outlier database has been analyzed, the blacklist in memory 306 is completed for the time being. It may be used in different ways.

The entries for those access points that are identified in the blacklist could be removed completely from the WLAN access point location database and thus from memory 406. (action 327) This may have the effect that storage space is saved and that the WLAN access point location database can be used without further consideration of the blacklist in memory 306.

Alternatively, entries in the WLAN access point location database for those access points that are identified in the blacklist in memory 306 could be blocked from being used in learning or positioning computations. This may also include action 312 of FIG. 4, in which set F may be selected such that it only includes those access points that are not identified in a previously determined blacklist, or action 315 of FIG. 4, in which set (F-O) may be further reduced by those access points that are identified in a previously determined blacklist. This may have the effect that available information on access points, that may be useful for other purposes, is not deleted. Furthermore, this may have the effect that more data is available for future statistical evaluations of outliers in line with actions 321 to 326.

It is to be understood that the distribution of functions to servers 300 and 400 presented with reference to FIGS. 4 to 7 is arbitrary and only exemplary. Any other distribution could be used as well, and additional servers or entities could be involved. For example, in one variation, server 400 could perform actions 313 and 314 as well, using a particular function of its positioning engine. In another variation, the entire operation presented with reference to FIGS. 4 and 7, with the exception of action 315, could be performed at server 300. In this case, the positioning requests of mobile terminals could be sent directly to server 300. In yet another variation, the entire operation presented with reference to FIGS. 4 and 7 could be performed at server 400, and also the outlier identifiers as well as the data for the blacklist could be stored in memory 406 of server 400. In case storage and/or processing capacity is an issue, though, storing and analyzing the outlier data on a separate server 300 may have the effect that there is no performance impact on the learning/positioning service at server 400.

In a particularly efficient approach, server 400 could serve the positioning request by determining the outliers and compute the position of the mobile terminal (actions 311-313 and 315) and signal server 300 the identifiers of those access points that were found to be outliers. The identifiers of the outliers could be stored by server 300 (action 314). Server 300 could then perform the analysis of the outlier data (actions 321-326) and, for instance, periodically publish an updated access point blacklist to server 400 so that server 400 may take account of the blacklist (action 327 or 328).

Summarized, certain embodiments of the invention may have the effect of resulting in a more reliable positioning service, because tethered devices can be detected automatically and blacklisted from learning/positioning.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:

(a) hardware-only circuit implementations (such as implementations in only analog and/or digital circuitry)

(b) combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone, to perform various functions) and

(c) to circuits, such as a microprocessor(s) or a portion of a microprocessor(s), that require software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or portion of a processor and its (or their) accompanying software and/or firmware. The term ‘circuitry’ also covers, for example, a baseband integrated circuit or applications processor integrated circuit for a mobile phone.

Any of the processors mentioned in this text could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Any of the memories mentioned in this text could be implemented as a single memory or as a combination of a plurality of distinct memories, and may comprise for example a read-only memory, a random access memory, a flash memory or a hard disc drive memory etc.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

The functions illustrated by processor 101 in combination with memory 102 or the integrated circuit 305 can also be viewed as means for receiving information on a first set of wireless local area network access points obtained in a scan at a single location, the information including at least an identifier of each access point; means for retrieving from a database, based on the identifiers, location data for a second set of access points, the second set of access points comprising access points of the first set of access points for which location data is available in the database; means for computing a position based on retrieved location data for the second set of access points; means for determining, based on a predetermined criterion, whether location data for any of the access points of the second set of access points represent an outlier in view of the computed position; and means for providing identifiers for a third set of access points that are not to be used for positioning purposes, the third set of access points comprising access points of the second set of access points for which the retrieved location data has been determined to represent outliers.

The program codes in memories 102 as well as 302 and 402, by themselves or in combination, can also be viewed as comprising such means in the form of functional modules.

FIGS. 2, 4 and 7 may also be understood to represent exemplary functional blocks of computer program codes supporting a verification of stored location data.

It will be understood that all presented embodiments are only exemplary, and that any feature presented for a particular exemplary embodiment may be used with any aspect of the invention on its own or in combination with any feature presented for the same or another particular exemplary embodiment and/or in combination with any other feature not mentioned. It will further be understood that any feature presented for an exemplary embodiment in a particular category may also be used in a corresponding manner in an exemplary embodiment of any other category.

1-19. (canceled)

20. A method by at least one apparatus, the method comprising:
receiving information on a first set of wireless local area network access points obtained in a scan at a single location, the information including at least an identifier of each access point;
retrieving from a database, based on the identifiers, location data for a second set of access points, the second set of access points comprising access points of the first set of access points for which location data is available in the database;
determining, based on retrieved location data for the second set of access points and on a predetermined criterion, whether location data for any of the access points of the second set of access points represent an outlier; and
providing identifiers for a third set of access points that are not to be used for positioning purposes, the third set of access points comprising access points of the second set of access points for which the retrieved location data has been determined to represent outliers.

21. The method according to claim 20, wherein the information on the first set of wireless local area network access points is received in a positioning request for a mobile device that collected the information in the scan, the method further comprising:
determining a position based on location data for access points of the second set of access points, excluding at least one of the access points of the third set of access points and access points identified in a blacklist; and
providing the determined position as a position of the mobile device.

22. The method according to claim 20, further comprising storing the identifiers of the third set of access points in a memory.

23. The method according to claim 20, further comprising assembling a blacklist based on identifiers of a plurality of provided third sets of access points, the blacklist identifying entries of the database that are not to be used for positioning purposes.

24. The method according to claim 23, further comprising
determining for a given company or organization identifier at least one of a number of access points in the third sets of access points and a ratio of access points in the third sets of access points, wherein a respective company or organization identifier is a part of an identifier of an access point; and
if the at least one of the number and the ratio exceeds a threshold value, adding the company or organization identifier to the blacklist.

25. The method according to claim 23, further comprising
determining for a given company or organization identifier whether there is a range of identifiers of access points for which at least one of a number of access points in the third sets of access points and a ratio of access points in the third sets of access points exceeds a threshold value, wherein a respective company or organization identifier is a part of an identifier of an access point; and
if the at least one of the number and the ratio exceeds the threshold value, adding information indicating the range of identifiers of access points to the blacklist.

26. The method according to claim 20, wherein the identifier of each access point comprises one of a basic service set identification and a medium access control address.

27. A system comprising at least one processor and at least one memory including computer program code, the at least one memory and the computer program code configured to, with the at least one processor, cause at least one apparatus at least to perform:
receive information on a first set of wireless local area network access points obtained in a scan at a single location, the information including at least an identifier of each access point;
retrieve from a database, based on the identifiers, location data for a second set of access points, the second set of access points comprising access points of the first set of access points for which location data is available in the database;
determine, based on retrieved location data for the second set of access points and on a predetermined criterion, whether location data for any of the access points of the second set of access points represent an outlier; and
provide identifiers for a third set of access points that are not to be used for positioning purposes, the third set of access points comprising access points of the second set of access points for which the retrieved location data has been determined to represent outliers.

28. The system according to claim 27, wherein the information on the first set of wireless local area network access points is received in a positioning request for a mobile device that collected the information in the scan, and wherein the computer program code is configured to, with the at least one processor, cause the at least one apparatus to:
determine a position based on location data for access points of the second set of access points, excluding at least one of the access points of the third set of access points and access points identified in a blacklist; and
provide the determined position as a position of the mobile device.

29. The system according to claim 27, wherein the computer program code is configured to, with the at least one processor, cause the at least one apparatus to store the identifiers of the third set of access points in a memory.

30. The system according to claim 27, wherein the computer program code is configured to, with the at least one processor, cause the at least one apparatus to assemble a blacklist based on identifiers of a plurality of provided third sets of access points, the blacklist identifying entries of the database that are not to be used for positioning purposes.

31. The system according to claim 30, wherein the computer program code is configured to, with the at least one processor, cause the at least one apparatus to:
determine for a given company or organization identifier at least one of a number of access points in the third sets of access points and a ratio of access points in the third sets of access points, wherein a respective company or organization identifier is a part of an identifier of an access point; and
add the company or organization identifier to the blacklist, if the at least one of the number and the ratio exceeds a threshold value.

32. The system according to claim 30, wherein the computer program code is configured to, with the at least one processor, cause the at least one apparatus to:
determine for a given company or organization identifier whether there is a range of identifiers of access points for which at least one of a number of access points in the third sets of access points and a ratio of access points in the third sets of access points exceeds a threshold value, wherein a respective company or organization identifier is a part of an identifier of an access point; and
if the at least one of the number and the ratio exceeds the threshold value, add information indicating the range of identifiers of access points to the blacklist.

33. The system according to claim 27, wherein the identifier of each access point comprises at least one of a basic service set identification and a medium access control address.

34. The system according to claim 27, wherein the system is at least one of:
an apparatus;
a server;
a component for a server;
a plurality of apparatuses; and
a plurality of servers.

35. A non-transitory computer readable storage medium in which computer program code is stored, the computer program code when executed by a processor causing at least one apparatus to perform the following:
receive information on a first set of wireless local area network access points obtained in a scan at a single location, the information including at least an identifier of each access point;
retrieve from a database, based on the identifiers, location data for a second set of access points, the second set of access points comprising access points of the first set of access points for which location data is available in the database;
determine, based on retrieved location data for the second set of access points and on a predetermined criterion, whether location data for any of the access points of the second set of access points represent an outlier; and
provide identifiers for a third set of access points that are not to be used for positioning purposes, the third set of access points comprising access points of the second set of access points for which the retrieved location data has been determined to represent outliers.
